(19) United States
(12) Patent Application Publication
(10) Pub. No.: US 2010/0106329 A1
(43) Pub. Date: Apr. 29, 2010

(54) APPARATUS AND METHOD FOR CONTROLLING AN ENVIRONMENTAL CONDITIONING SYSTEM

(75) Inventor: Wojciech Grohman, Little Elm, TX (US)

Correspondence Address: HITT GAINES P.C., P.O. BOX 832570, RICHARDSON, TX, 75083, US

(73) Assignee: Lennox Manufacturing, Inc., a Corporation of Delaware, Richardson, TX (US)

(21) Appl. No.: 12/258,659

(22) Filed: Oct. 27, 2008

(51) Int. Cl. G05B 15/00

(52) U.S. Cl. 700/277

(57) ABSTRACT

An apparatus for controlling an environmental conditioning system serving an indoor space and having at least one environmental conditioning device coupled with a communication bus structure includes: (a) at least one user interface coupled with the communication bus structure for effecting access to the system by a user; and (b) at least one controller coupled with the communication bus structure for effecting operational control of the system. The at least one controller communicates on the communication bus structure with the at least one environmental conditioning device, the at least one user interface and any other devices coupled with the communication bus structure. The at least one user interface communicates on the communication bus structure with the at least one environmental conditioning device, the at least one controller and any other devices coupled with the communication bus structure.

### FIELD OF THE INVENTION

The present invention is directed to systems for environmentally conditioning indoor spaces, such as heating, ventilating and air conditioning (HVAC) systems, and especially to HVAC systems having a plurality of devices coupled with a communication bus structure.

### BACKGROUND OF THE INVENTION

Environmental conditioning systems, such as heating, ventilating and air conditioning (HVAC) systems, traditionally include a system controller such as, by way of example and not by way of limitation, a thermostat or a humidistat. The controller traditionally includes a comfort sensor and a user interface as integral and non-separable parts thereof. The user interface may be employed by a user for establishing one or more set points for the HVAC system. By way of example and not by way of limitation, a user may employ a user interface with a controller for setting a temperature to be maintained by an HVAC system.

Lately there have been introduced what are known as communicating HVAC systems. Communicating HVAC systems effect connection among various components or portions of a system using communicating connections so that control of the system may be carried out in a more flexible manner, as will be understood by those skilled in the art of designing communicating HVAC systems. For example, in the communicating HVAC system 1 shown in FIG. 1, a thermostat 2 includes network interface hardware 2a, system controller hardware and software 2c, user interface hardware 2b and comfort sensor hardware 2d, which are electrically coupled together in a common housing. Thermostat 2 communicates with external devices that include furnace 6, outdoor sensor 7, outdoor unit 8 and gateway 9 via a communication bus 4. Inside of thermostat 2, system controller 2c communicates with user interface hardware 2b via a connection 3a, communicates with network interface hardware 2a via a connection 3c and with comfort sensor hardware 2d via a connection 3b, all of which connections are internal to thermostat 2. User interface hardware 2b and comfort sensor hardware 2d are not connected to communication bus 4. The software running on system controller 2c manages its operation, as well as the operation of all of the hardware of thermostat 2, including user interface hardware 2b, comfort sensor hardware 2d and network interface hardware 2a. Network interface hardware 2a allows system controller 2c to communicate over communication bus 4.

Some difficulties may be encountered in designing a communicating HVAC system such as, by way of example and not by way of limitation, when the system serves a plurality of indoor spaces. For example, if the HVAC system is a zoned system that serves a plurality of indoor spaces in different zones, a plurality of comfort sensors and user interfaces may be needed. This typically requires a plurality of thermostats, each of which has complex control circuitry as well as a comfort sensor and user interface. Problems may also be encountered when updating an existing system, especially in assuring backwards compatibility between an updated system and earlier versions of the system. For example, if a furnace component of the HVAC system is replaced, a new system controller is typically required, which entails a new thermostat having not only control circuitry, but also a user interface and a comfort sensor.

There is a need for an apparatus and method for controlling an HVAC system that facilitates including multiple comfort sensors and/or user interfaces in the HVAC system.

There is also a need for an apparatus system and method for controlling an HVAC system that facilitates updating of all or a portion of the system while permitting backwards compatibility with earlier versions of the system.

### SUMMARY OF THE INVENTION

In accordance with an embodiment of the invention, the three devices of an environmental control apparatus, namely, a controller, an environmental sensor and a user interface, are configured as logical devices, independent of one another, so they do not have to be housed together. Each of these devices contains both the hardware required to support it and the dedicated software that is run independently of the other devices' software.

In accordance with another embodiment of the invention, apparatus is provided for controlling an environmental conditioning system serving an indoor space and having at least one environmental conditioning device coupled with a communication bus structure. The apparatus includes: (a) at least one user interface coupled with the communication bus structure for effecting access to the system by a user; and (b) at least one controller coupled with the communication bus structure for effecting operational control of the system. The at least one controller communicates on the communication bus structure with the at least one environmental conditioning device, the at least one user interface and any other devices coupled with the communication bus structure. The at least one user interface communicates on the communication bus structure with the at least one environmental conditioning device, the at least one controller and any other devices coupled with the communication bus structure.

In accordance with still another embodiment of the invention, the apparatus includes at least one sensor for sensing at least one environmental parameter. The at least one sensor communicates on the communication bus structure with the at least one controller, the at least one user interface, the at least one environmental conditioning device and with any other devices coupled with the communication bus.

In accordance with yet another embodiment of the invention, apparatus is provided for controlling an environmental conditioning system serving an indoor space and having at least one environmental conditioning device coupled with a communication bus structure. The apparatus includes: (a) at least one sensor coupled with the communication bus structure for sensing at least one environmental parameter; and (b) at least one user interface coupled with the communication bus structure for effecting access to the system by a user. The at least one user interface is able to communicate on the communication bus structure with the at least one sensor, the at least one environmental conditioning device and with any other devices coupled with the communication bus structure. The at least one sensor is able to communicate on the communication bus structure with the at least one sensor, the at least one environmental conditioning device and with any other devices coupled with the communication bus structure.

In accordance with a further embodiment of the invention, apparatus is provided for controlling an environmental conditioning system serving and indoor space. The apparatus includes: (a) at least one sensor coupled with a communication bus structure for sensing at least one environmental parameter; and (b) at least one environmental conditioning device coupled with the communication bus structure. The at least one environmental conditioning device is able to communicate on the communication bus structure with the at least one sensor and with any other devices coupled with the communication bus structure. The at least one sensor is able to communicate on the communication bus structure with the at least one environmental conditioning device and any other devices coupled with the communication bus structure.

In accordance with a still further embodiment of the invention, a method is provided for controlling an environmental conditioning system serving an indoor space having at least one environmental conditioning device coupled with a communication bus structure. The method includes in no particular order: (1) providing at least one user interface device coupled with the communication bus structure; and (2) providing at least one control device coupled with the communication bus structure; and (3) providing at least one sensor device coupled with the communication bus structure; and (4) providing at least one environmental conditioning device coupled with the communication bus structure. Any combination of these four devices can be housed together in the same physical unit. Alternatively, any combination of any two or more of the four devices can be housed together in the same physical unit, or all four devices can be housed in separate physical units. The method further includes in no particular order: (1) operating the at least one user interface device to effect access to the system by a user; and (2) operating the at least one control device to effect operational control of the system by communicating with the at least one environmental conditioning device and the at least one interface device on the communication bus structure; and (3) operating the at least one sensor device for sensing the at least one environmental parameter.

There is no limit on the number of possible units of any kind coupled with the communicating bus structure whether housed in one apparatus or in many.

It is, therefore, a feature of the present invention to provide an apparatus and method for controlling an environmental conditioning system that facilitates including multiple sensor units in the system.

Multiple controllers, each of which can control the entire system on the same communicating bus structure, can be added as part of or in association with new devices added to the communicating bus structure. Therefore, it is a further feature of the present invention to provide an apparatus and method for controlling an environmental conditioning system that facilitates updating of all or a portion of the system while permitting backwards compatibility with earlier versions of the system.

It is yet another feature of the present invention to provide an apparatus and method for controlling an environmental conditioning system that logically separates control of the system from the sensor device(s) and user interface device(s) in the system.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram of a simple prior art HVAC system;

FIG. 2 is a schematic diagram of a simple HVAC system configured according to the teachings of the present invention.

FIG. 3 is a schematic diagram of a more complex HVAC system than the system illustrated in FIG. 1 configured according to the teachings of the present invention.

FIG. 4 is a flow chart illustrating a method in accordance with an embodiment the present invention.

### DETAILED DESCRIPTION OF THE PREFERRED EMBODIMENT

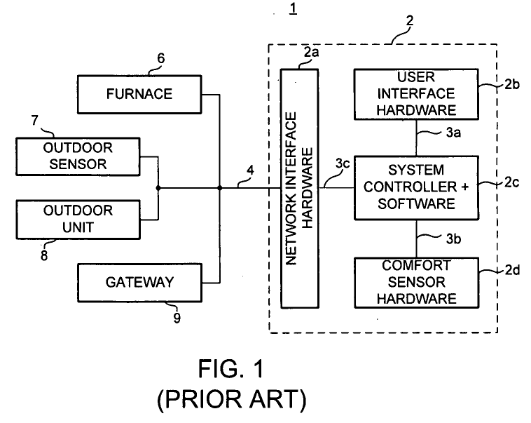

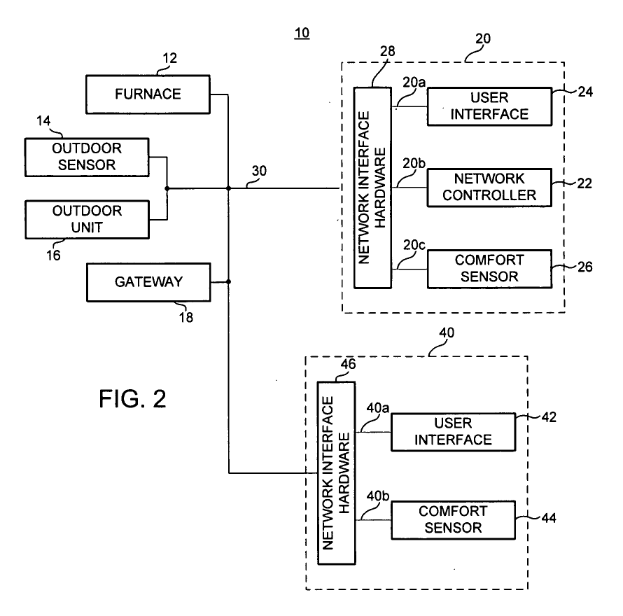

Referring now to FIG. 2, a heating, ventilating and air conditioning (HVAC) system 10 includes a furnace 12, an outdoor sensor unit 14, an outdoor unit 16 and a gateway unit 18. Furnace 12, outdoor sensor unit 14, outdoor unit 16 and gateway unit 18 are communicatingly coupled with a communication bus 30. Communication bus 30 may be embodied in, by way of example and not by way of limitation, a RS (Residential System) Bus. HVAC system 10 may serve a plurality of spaces and/or zones within a building (not shown in detail in FIG. 1), as is known by those skilled in the art of HVAC installation design.

HVAC system 10 also includes control apparatuses 20 and 40 for controlling HVAC system 10. Control apparatus 20 includes a network controller 22, a user interface 24, a comfort sensor 26 and network interface hardware 28. Control apparatus 40 includes a user interface 42, a comfort sensor 44 and network interface hardware 46. Network controller 22 of control apparatus 20 is communicatingly coupled through network interface hardware 28 with communication bus 30 for effecting operational control of HVAC system 10. User interfaces 24 and 42 of control apparatus 20 and 40 are communicatingly coupled through network interface hardware 28 and 46, respectively, with communication bus 30 for effecting access to HVAC system 10 by a user. Comfort sensors 26 and 44 of control apparatus 20 and 40 are communicatingly coupled through network interface hardware 28 and 46, respectively, with communication bus 30 for sensing a predetermined environmental parameter such as, by way of example and not by way of limitation, temperature. Communications on communication bus 30 are preferably carried out using digital communications.

User interface 24 of apparatus 20 communicates with network interface hardware 28 through connection 20a. Network controller 22 of apparatus 20 communicates with network interface hardware 28 through connection 20b. Comfort sensor 26 of apparatus 20 communicates with network interface hardware 28 through connection 20c. Likewise, user interface 42 of apparatus 40 communicates with network interface hardware 46 through connection 40a. Comfort sensor 44 of apparatus 40 communicates with network interface hardware 46 through connection 40b. The terms “user interface”, “comfort sensor” and “network controller” include not only these respective devices, but also include both the hardware and the software required for the respective devices to function.

The user exercises the control of the system by accessing network controller 22 through available user interfaces 24 and 42. The communication between user interface 24 and network controller 22 is through the connection 20a, network interface hardware 28, communication bus 30, back through network interface hardware 28 and connection 20b. Similarly, the communication between user interface 42 and network controller 22 is through the connection 40a, network interface hardware 46, communication bus 30, network interface hardware 28 and connection 20b.

Alternatively, the communication path between user interface 24 and network controller 22 may be through the connection 20a, network hardware interface 28 and connection 20b.

Each of network controller 22, user interface 24 and comfort sensor 26 can be embodied in an individual autonomous unit that may be coupled with communication bus 30 anywhere within HVAC system 10, so that network controller 22, user interface 24 and comfort sensor 26 are not necessarily located together or even in the same indoor space. Alternatively, any two or more of network controller 22, user interface 24 and comfort sensor 26 may be combined in a single physical unit and the remaining unit, if any, of network controller 22, user interface 24 and comfort sensor 26 may be an individual autonomous unit. In this alternate embodiment, the combined unit (i.e., any two or more of network controller 22, user interface 24 and comfort sensor 26) and the remaining unit, if any, of network controller 22, user interface 24 and comfort sensor 26 may be coupled with communication bus 30 anywhere within HVAC system 10. Whether or not any two or more of network controller 22, user interface 24 and comfort sensor 26 are combined in a single physical unit, network controller 22, user interface 24 and comfort sensor 26 are logically separate devices as far as communication on bus 30 is concerned. Similarly, user interface 42 and comfort sensor 44 are logically separate devices as far as communication on bus 30 is concerned. They may be housed together in a single unit 40, as shown in FIG. 2, or housed in separate physical units.

It is preferred that HVAC system 10 be configured to effect differential signaling among components, as will be understood by those skilled in the art of HVAC design and installation.

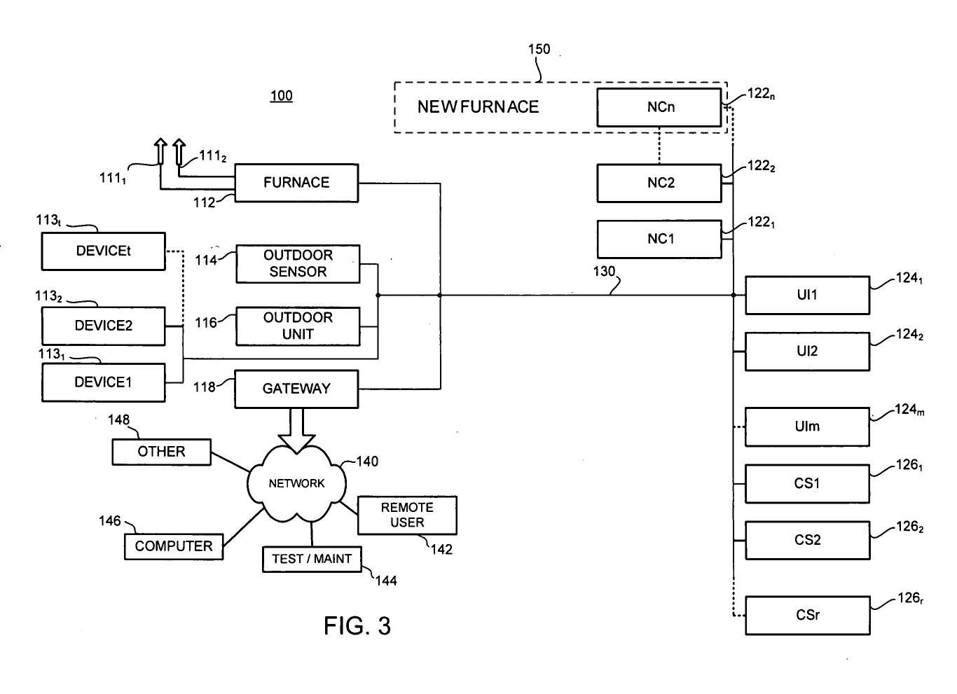

Referring to FIG. 3, a heating, ventilating and air conditioning (HVAC) system 100 includes a furnace 112, an outdoor sensor unit 114, an outdoor unit 116 and a gateway unit 118. HVAC system 100 also includes a plurality of devices 113₁, 113₂, 113ₜ. The indicator “t” is employed to signify that there can be any number of devices in HVAC system 100. The inclusion of three devices 113₁, 113₂, 113ₜ in FIG. 3 is illustrative only and does not constitute any limitation regarding the number of devices that may be included in HVAC system 100. HVAC system 100 also includes a plurality of network controllers (NC) 122₁, 122₂, 122ₙ. The indicator “n” is employed to signify that there can be any number of network controllers in HVAC system 100. The inclusion of three network controller 122₁, 122₂, 122ₙ in FIG. 3 is illustrative only and does not constitute any limitation regarding the number of network controllers that may be included in HVAC system 100.

HVAC system 100 also includes a plurality of user interfaces (UI) 124₁, 124₂, 124ₘ. The indicator “M” is employed to signify that there can be any number of user interfaces in HVAC system 100. The inclusion of three user interfaces 124₁, 124₂, 124ₘ in FIG. 3 is illustrative only and does not constitute any limitation regarding the number of user interfaces that may be included in HVAC system 100.

HVAC system 100 also includes a plurality of comfort sensors (CS) 126₁, 126₂, 126ᵣ. The indicator “r” is employed to signify that there can be any number of comfort sensors in HVAC system 100. The inclusion of three comfort sensors 126₁, 126₂, 126ᵣ in FIG. 32 is illustrative only and does not constitute any limitation regarding the number of comfort sensors that may be included in HVAC system 100.

All components of HVAC system 100 are communicatingly coupled with a communication bus 130. That is, furnace 112, outdoor sensor unit 114, outdoor unit 116 and gateway unit 118 are communicatingly coupled with communication bus 130. Further, devices 113ₜ, network controllers 122ₙ, user interfaces 124ₘ, comfort sensors 126ᵣ are communicatingly coupled with communication bus 130. HVAC system 100 may serve a plurality of spaces within a building (not shown in detail in FIG. 3), as is known by those skilled in the art of HVAC installation and design. Communications on communication bus 130 are preferably carried out using digital communications.

Outdoor sensor unit 114 may be embodied in, by way of example and not by way of limitation, an outdoor temperature sensing unit. Outdoor unit 116 may be embodied in, by way of example and not by way of limitation, a heat pump unit. Devices 113ₜ may be embodied in, by way of example and not by way of limitation, a plurality of similar devices, such as dehumidifier units or may be embodied in a plurality of different types of units such as, by way of example and not by way of limitation, humidifiers, dehumidifiers, ozone removal devices or other devices.

Devices 113ₜ, network controllers 122ₙ, user interfaces 124ₘ and comfort sensors 126ᵣ may be distributed among a plurality of spaces or zones served by HVAC system 100 and may be various models of their respective units.

Communication bus 130 maybe embodied in, by way of example and not by way of limitation, a RS (Residential System) Bus.

Each network controller 122ₙ, user interface 124ₘ and comfort sensor 126ᵣ is preferably embodied in an individual autonomous unit that may be coupled with communication bus 130 anywhere within HVAC system 100. Alternatively, any two or more of a network controller 122ₙ, a user interface 124ₘ and a comfort sensor 126ᵣ may be combined in a single unit and the remaining unit, if any, of network controller 122ₙ, a user interface 124ₘ and a comfort sensor 126ᵣ may be an individual autonomous unit. In this alternate embodiment, the combined unit (i.e., any two or more of a network controller 122ₙ, a user interface 124ₘ and a comfort sensor 126ᵣ) and the remaining unit, if any, of a network controller 122ₙ, a user interface 124ₘ and a comfort sensor 126ᵣ may be coupled with communication bus 130 anywhere within HVAC system 100.

When more than one network controller 122ₙ is included within HVAC system 100 it is preferred that only one of the installed network controllers 122ₙ operates to effect control of HVAC system 100 while other network controllers 122ₙ store pertinent information relating to operation of HVAC system 100. Which network controller 122ₙ is designated for controlling HVAC system 100 may be determined using any criteria. By way of illustration and not by way of limitation, the network controller 122ₙ having the most recently issued serial number may be selected to control HVAC system 100. By way of illustration and not by way of limitation, other non-controlling network controllers 122ₙ may store device identifications of all other network controllers units 122ₙ and the latest information relating to active, inactive or disabled states of each component of HVAC system 100.

Other HVAC systems (not shown in FIG. 3) may be coupled with HVAC installation 100 by coupling with communication bus 130 or by coupling via a selected device or unit of system 100, such as furnace 112, as indicated at loci 111₁, 111₂.

It is preferred that HVAC system 100 be configured to effect differential signaling among components, as will be understood by those skilled in the art of HVAC installation design.

One skilled in the art will recognize that locating each network controller 122ₙ user interface 124ₘ and comfort sensor 126ᵣ separately from one another allows replacements or additions to these devices to be effected without having to replace or add to the other devices. For example, replacing furnace 112 with new furnace 150 may require the addition of a network controller 122ₙ that is compatible with new furnace 150. However, it would not be necessary to add a new user interface 124ₘ or a new comfort sensor 126ᵣ as would be the case if these three units were housed together in a conventional thermostat configuration. It would also be possible to simply replace furnace 112 with a new furnace 150 that contains network controller 122ₙ embedded as a logical device in the control board of new furnace 150. Further, by way of example, it may be desirable to install a comfort sensor and/or a user interface in a plurality of indoor spaces for more precise environmental control in a zoned HVAC system. However, in that case, it would not be necessary to install a conventional thermostat in each space because a controller would not be needed in each space.

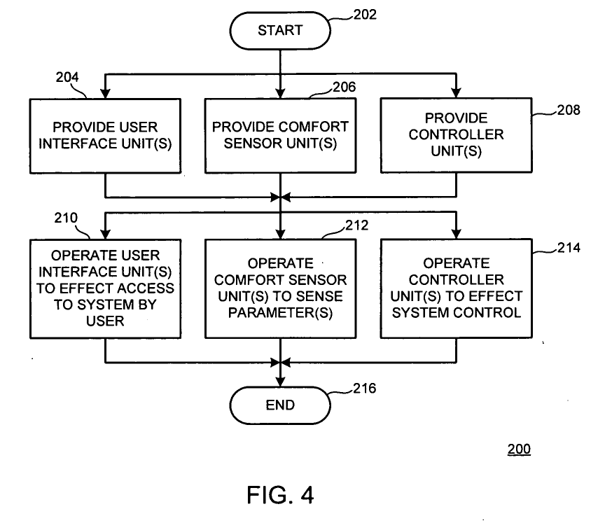

Referring now to FIG. 4, a method for controlling a heating, ventilating and air conditioning (HVAC) system, such as HVAC system 10 in FIG. 2 or HVAC system 100 in FIG. 3, serving a plurality of spaces begins at a START locus 202. The installation includes a plurality of environmental conditioning units and/or devices coupled with a communication bus structure.

Method 200 continues with, in no particular order: (1) providing at least one user interface unit coupled with the communication bus structure, as indicated by a block 204; (2) providing at least one comfort sensor unit coupled with the communication bus structure, as indicated by a block 206; and (3) providing at least one controller unit coupled with the communication bus structure, as indicated by a block 208.

Method 200 continues with, in no particular order: (1) operating the at least one user interface unit to effect access to the HVAC system by a user, as indicated by a block 210; (2) operating the at least one comfort sensor unit to sense at least one predetermined environmental parameter, as indicated by a block 212; and (3) operating the at least one controller unit to effect operational control of the HVAC system, as indicated by a block 214.

Method 200 terminates at an END locus 216.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims.

I claim:

1. Apparatus for controlling an environmental conditioning system for an indoor space; said system including at least one environmental conditioning unit coupled with a communication bus structure; the apparatus comprising:
(a) at least one user interface for effecting access to the system by a user; each respective user interface of said at least one user interface being coupled with said communication bus structure; and
(b) at least one controller for effecting operational control of the system; each respective controller of said at least one controller being coupled with said communication bus structure; said at least one controller and said at least one user interface being adapted to communicate on the communication bus structure with one another, with said at least one environmental conditioning unit and with any other device coupled to the communication bus structure.

2. Apparatus as recited in claim 1 further including at least one sensor for sensing at least one environmental parameter, said at least one sensor being coupled to said communication bus structure and being adapted to communicate on the communication bus structure with said at least one controller, said at least user interface, said at least one environmental conditioning unit and any other device coupled to the communication bus structure.

3. Apparatus as recited in claim 2 wherein said system serves a plurality of indoor spaces, said at least one sensor being comprised of a plurality of sensors distributed among said plurality of spaces for sensing at least one environmental parameter in the respective spaces.

4. Apparatus as recited in claim 2 wherein said at least one controller, said at least one user interface and said at least one sensor are separate logical units.

5. Apparatus as recited in claim 1 wherein said at least one controller is comprised of plural controllers distributed among a plurality of loci of said communication bus structure.

6. Apparatus as recited in claim 1 wherein said system serves a plurality of indoor spaces, said at least one user interface being comprised of plural user interfaces distributed among said plurality of indoor spaces.

7. Apparatus as recited in claim 1 wherein said system serves a plurality of indoor spaces, said at least one controller being comprised of a plurality of controllers distributed among a plurality of loci of said communication bus structure, said at least one user interface being comprised of a plurality of user interfaces distributed among said plurality of indoor spaces.

8. Apparatus as recited in claim 7 further including a plurality of sensors distributed among said plurality of indoor spaces for sensing at least one environmental parameter in the respective indoor spaces, each of said sensors being coupled to said communication bus structure and being adapted to communicate on the communication bus structure with said controllers, said user interfaces, said at least one environmental conditioning unit and any other device coupled to the communication bus structure.

9. Apparatus for effecting control of an environmental conditioning system serving at least one indoor space; said system including at least one physical unit communicatingly coupled with a communication bus network; the apparatus comprising: a plurality of logical devices coupled with said communication bus network; a first logical device of said plurality of logical devices comprising at least one sensor for sensing at least one environmental parameter, said at least one sensor being coupled with the communication bus network; a second logical device of said plurality of logical devices comprising at least one user interface coupled with said communication bus network for effecting user access to the system; said at least one sensor and said at least one user interface being adapted to communicate on said communication bus network with one another, with said at least one physical unit and with any other device coupled to the communication bus network.

10. Apparatus as recited in claim 9 wherein said at least one sensor is comprised of plural comfort sensors distributed among a plurality of indoor spaces served by said system for sensing an environmental parameter in the respective spaces.

11. Apparatus as recited in claim 9 further including a third logical device comprising at least one network controller coupled to the communication bus network for effecting control of the system via the communication bus network, said network controller being adapted to communicate on the communication bus network with said at least one physical unit, said at least one sensor, said at least one user interface and any other device coupled to the communication bus network.

12. Apparatus as recited in claim 11 wherein one of said at least one sensor and one of said at least one user interface are housed together in a single unit separate from said at least one network controller.

13. Apparatus as recited in claim 11 wherein one of said at least one sensor, one of said at least one user interface and one of said at least one network controller are housed together in a single unit, but are separate logical devices.

14. Apparatus as recited in claim 9 wherein one of said at least one sensor and one of said at least one user interface are housed together in a single unit, but are separate logical devices.

15. Apparatus as recited in claim 9 wherein said at least one sensor and said at least one user interface are separate physical units and separate logical devices.

16. A method for controlling an environmental conditioning system serving at least one indoor space; said installation including at least one environmental conditioning unit coupled with a communication bus structure; the method comprising:
(a) in no particular order:
(1) providing at least one user interface coupled with said communication bus structure;
(2) providing at least one sensor coupled with said communication bus structure; and
(3) providing at least one controller coupled with said communication bus structure, so that said at least one controller, said at least one user interface and said at least one sensor are adapted to communicate on said communication bus structure with one another, with said environmental conditioning unit and with any other device coupled to said communication bus structure; and
(b) in no particular order:
(1) operating said at least one user interface unit to effect access to said system by a user;
(2) operating said at least one sensor unit to sense at least one predetermined environmental parameter; and
(3) operating said at least one controller unit to effect operational control of the system by communicating with the at least one environmental conditioning unit, the at least one user interface unit and the at least one sensor unit on the communication bus structure.

17. A method as recited in claim 16 further including distributing at least one of said at least one user interface unit, said at least one sensor unit and said at least one controller unit among a plurality of loci of said communication bus structure.

18. An environmental conditioning system for an indoor space; said system including an environmental conditioning unit coupled with a communication bus and a sensor for sensing a predetermined environmental parameter used to control the environmental conditioning unit; said comfort sensor being coupled with said communication bus; said environmental conditioning unit and said sensor being adapted to communicate on the communication bus with each other and with any other device coupled to the communication bus.

19. The system as recited in claim 18 further including a controller coupled to the communication bus for effecting control of the system via the communication bus, said controller being adapted to communicate on the communication bus with said environmental conditioning unit, said sensor and any other device coupled to the communication bus.

20. The system as recited in claim 19 wherein said controller is located with said environmental conditioning unit.

21. Apparatus as recited in claim 20 wherein said environmental conditioning unit is a furnace.

22. Apparatus as recited in claim 19 wherein said controller is at a different location on said communication bus from said sensor.

23. Apparatus as recited in claim 19 wherein said controller and said sensor are located together in a single unit.
